(19) United States
(12) Patent Application Publication
(10) Pub. No.: US 2013/0096979 A1
(43) Pub. Date: Apr. 18, 2013

(54) SYSTEM FOR MONITORING SAFETY PROTOCOLS

(71) Applicant: Ken BINGHAM, Rocky Mountain House (CA)

(72) Inventor: Ken BINGHAM, Rocky Mountain House (CA)

(73) Assignee: ACM AUTOMATION INC., Calgary (CA)

(21) Appl. No.: 13/271,711

(22) Filed: Oct. 12, 2011

(51) Int. Cl. G06Q 10/06

(52) U.S. Cl. 705/7.28

(57) ABSTRACT

Systems and methods for monitoring safety procedures for an industrial facility. A user interface for a safety operator interfaces with a database containing safety documents for components installed and in use in the industrial facility. The user interface also interfaces with a safety calculation module that calculates the risk level for specific potential consequences if specific safety procedures are not implemented. Whenever a potentially unsafe situation occurs, the risk levels associated with the potential consequences of the unsafe situation are presented to the safety operator along with contingencies which may be implemented to alleviate the risks. Past potentially unsafe situations are also presented to the safety operator by way of a time line such that a historical record of the safety of the facility can be taken in at a glance.

### TECHNICAL FIELD

The present invention relates to industrial equipment safety. More specifically, the present invention relates to systems and methods for determining if safety procedures for industrial equipment are being implemented and for determining consequences of a non-implementation of these safety procedures.

### BACKGROUND OF THE INVENTION

Large-scale industrial accidents due to the failure of industrial equipment should be a thing of the past. Industrial facilities, especially those relating to chemical processes, can now be designed with safety procedures in mind. These safety procedures include periodic scheduled safety checks on the various components of such a facility. Components such as valves, pipes, seals, instruments, and others have regularly scheduled maintenance checks and the safety workers performing the checks can report back as to whether the components are in good condition or whether they need to be replaced.

Unfortunately, the scheduled maintenance checks are not always the easiest to keep track of and, invariably, these safety checks can be missed. This is especially true for facilities with hundreds if not thousands of components that need checking.

Another issue with the maintenance and checking of components is that safety workers are not usually cognizant of the consequences of equipment failure or of the risks being run due to failing equipment. These potential consequences are usually known at the time the facility is designed and at the time the components are provisioned. However, as with the scheduled safety maintenance checks, these potential consequences may easily get lost as the facility and its equipment ages.

If the components fail, these potential consequences may be quite dire for the facility. Injuries, even deaths, are possible.

There is therefore a need for systems or methods that can be used to monitor not merely the scheduled maintenance safety check schedules but the possible consequences for missing these safety checks as well as ignoring or not implementing safety procedures.

### SUMMARY OF INVENTION

The present invention relates to systems and methods for monitoring safety procedures for an industrial facility. A user interface for a safety operator interfaces with a database containing safety documents for components installed and in use in the industrial facility. The user interface also interfaces with a safety calculation module that calculates the risk level for specific potential consequences if specific safety procedures are not implemented. Whenever a potentially unsafe situation occurs, the risk levels associated with the potential consequences of the unsafe situation are presented to the safety operator along with contingencies which may be implemented to alleviate the risks. Past potentially unsafe situations are also presented to the safety operator by way of a time line such that a historical record of the safety of the facility can be taken in at a glance.

In a first aspect, the present invention provides a system for monitoring safety related procedures relating to specific components in a facility, the system comprising:
a safety operator user interface for providing a safety operator with alerts and information relating to a plurality of components in said facility;
a database of safety related documents, said documents being accessed by said user interface to determine if safety procedures for said plurality of components are being implemented;
a safety calculation module for calculating risk levels if said safety procedures for said plurality of components are not implemented, said risk levels being presented to said safety operator through said user interface, said risk levels being related to at least one consequence if said safety procedures are not implemented.

In a second aspect, the present invention provides a system for monitoring safety related procedures relating to specific components in a facility, the system comprising:
a user interface for providing alerts and information relating to said specific components;
a database of safety related documents, said documents being accessed by said user interface to determine if safety procedures for said specific components are being implemented;
a safety calculation module for calculating risk levels relating to potential consequences if said safety procedures for said specific components are not implemented, said risk levels being presented to said safety operator through said user interface.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a screen shot of a dashboard screen of a user interface according to one aspect of the invention;

FIG. 3 is a screen shot of a situational analysis screen of the user interface;

FIG. 4 is a screen shot of an alarm notes view of the situational analysis screen;

FIG. 5 is a screen shot of a contingencies view of the situational analysis screen;

FIG. 6 is a screen shot of an observation view of the situational analysis screen;

FIG. 7 is a screen shot of a history view of the situational analysis screen;

FIG. 8 is a screen shot of another contingencies view of the situational analysis screen; and

FIG. 9 is a screen shot showing a popup window that occurs when a component fails.

### DETAILED DESCRIPTION OF THE INVENTION

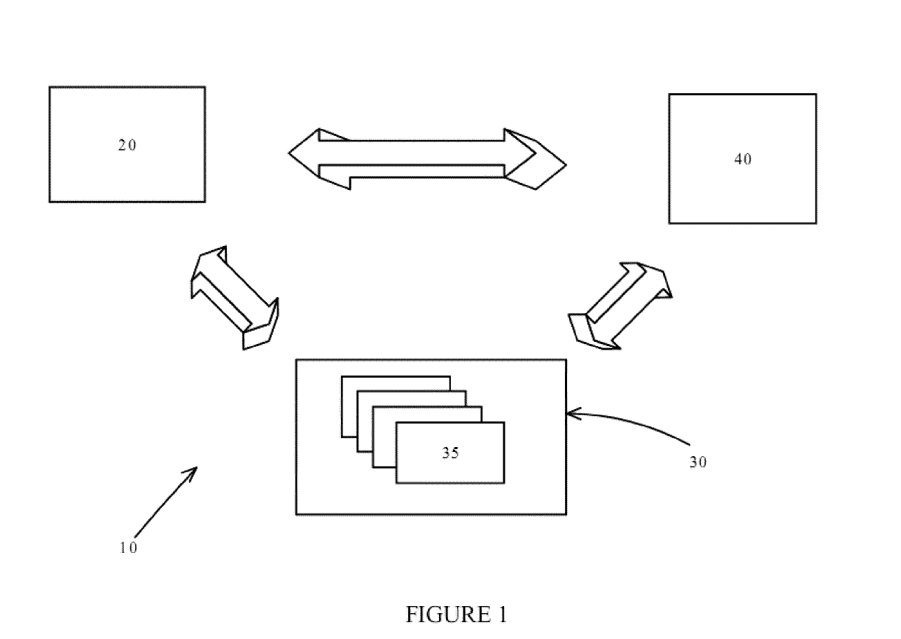

Referring to FIG. 1, a block diagram of a system according to one aspect of the invention is illustrated. The system 10 comprises a user interface 20, a database 30, and a calculation module 40.

The system illustrated and described below can be used to implement aspects of the international standard IEC61511.

The database 30 contains safety documents 35 for the components being used in a specific facility. The safety documents are preferably documents prepared by design engineers while designing and constructing the facility or its related systems. Also preferably, each component and subcomponent of the facility is provided with a corresponding safety document that documents the projected life span of the component, a suitable maintenance schedule for the component, a suitable safety inspection schedule for the document, as well as other useful safety related data and metrics for the component or subcomponent. In one implementation, the safety documents 35 in the database 30 can be the Safety Requirement Specification (SRS) documents for each component in the facility. These SRS documents ideally detail potential consequences if a specific component fails or performs in a manner less than what is expected from the component. The SRS document may also contain rules and information relating to the calculation of risk levels for each of the potential consequences if the specific component fails.

The calculation module 40 calculates the various risk levels associated with each of the potential consequences if the specific component fails or functions in a less than expected manner. These risk levels are calculated using data derived from the safety documents in the database 30. These risk levels are accessible to the user interface 20. As will be seen below, risk levels can be presented to the safety operator using various user interfaces. One example of a calculation that the calculation module may make is the PFD or the probability of failure on demand for each component. The PFD of a safety instrumented function (SIF) loop can be calculated using:

$${PFD}_{IEC} = {λ}_{D} [ ( 1 - D C ) ( \frac{{T}_{I}}{2} + MTTR ) + ( D C \times MTTR ) ]$$

where
PFD_{IEC} is the probability of failure of demand of the component per IEC 61508
λ_{D} is the dangerous failure rate of the component
DC is the diagnostic coverage applied to the component
Tᵢ is the proof test interval for the component
MTTR is the mean time to restore a component from failed to working state.

To avoid probabilities greater than 1, the equation below may be used by the calculation module 40:

PFD_{True}=1−e^{-PFD}^{_{IEC}}

For independent components in MooN combinations (i.e. M out of N elements must work for the component to work), the equation below has been used for all combinations where M≦N:

$${PFD}_{Total} = {\sum }_{i = N - M + 1}^{N} \frac{N !}{i ! ( N - I ) !} ( {( {PFD}_{True} )}^{N} {( 1 - {PFD}_{True} )}^{N - i} )$$

For common cause failures in redundant combinations, the PFD can be calculated using:

$${PFD}_{Total} = \{ {\sum }_{i = N - M + 1}^{N} \frac{N !}{i ! ( N - i ) !} ( {( {PFD}_{True} )}^{N} {( 1 - {PFD}_{True} )}^{N - i} ) \} + ( β \times {PFD}_{True} )$$

where β is the common cause factor between redundant elements. Other calculations performed by the calculation module may be found in the 61511-61508 IEC standards (IEC being the International Electrotechnical Commission).

The user interface 20 presents data to a safety operator upon which the safety operator will base his or her decisions regarding the safety of the facility. The user interface 20 has a number of screens from which the safety operator can see various data relating to potentially unsafe situations as well as contingencies which may be implemented.

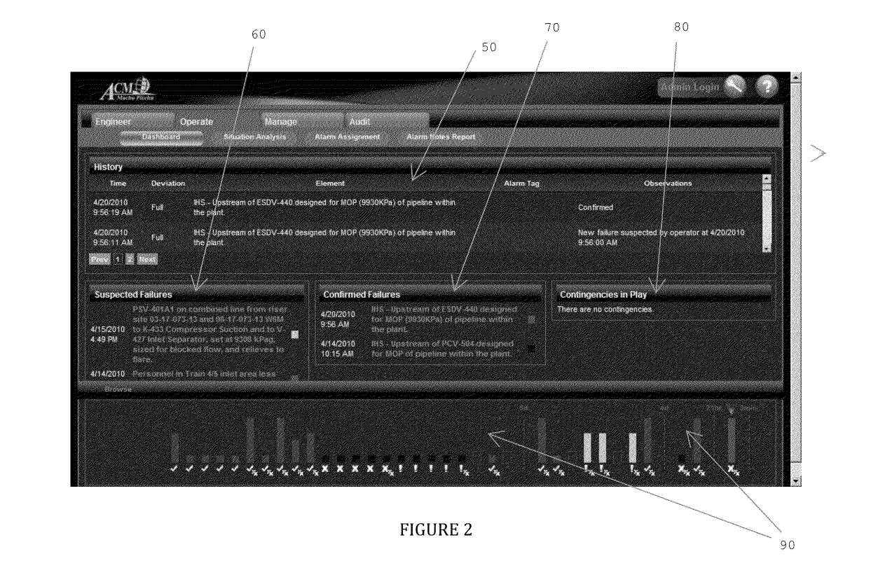

Referring to FIG. 2, a screen shot of one user interface screen according to one implementation is illustrated. FIG. 2 shows a dashboard screen of the user interface 20. As can be seen, a history section 50 details a history of previous alarms or potentially unsafe situations. The history section 50 details the element or component to which the alarm relates as well as the date and time of the alarm. Finally, the history section details observations made by the safety operator regarding each of the alarms. This history section can be scrolled down to show more entries of previous alarms.

Also shown in FIG. 2 are suspected failures 60 as well as confirmed equipment or component failures 70. These sections identify the component, the date/time of the suspected or confirmed failure, and, using a color coded system, the risk of consequences due to the component failures. Also present is a contingencies section 80. This section shows any contingencies that are currently implemented due to safety concerns. As can be seen, no contingencies are in effect.

FIG. 2 also shows a quick reference timeline 90 at the bottom of the user interface screen. The timeline shows the various alarms or potentially unsafe situations that have occurred or could have occurred. New color coded icons or bars representing potentially unsafe situations enter from the right of the user interface along with a changing time bar detailing how much time has elapsed since the potentially unsafe situation was detected. As can be seen from FIG. 2, the potentially unsafe situation represented by the red bar occurred 3 minutes before and has not been addressed. The color coding used in this implementation uses a red color to detail a potentially serious situation with dire consequences while a yellow color details a less serious situation. From FIG. 2, it can be seen that, prior to the current potentially unsafe situation (detailed by the red bar), the previous event was more than 21 hours ago.

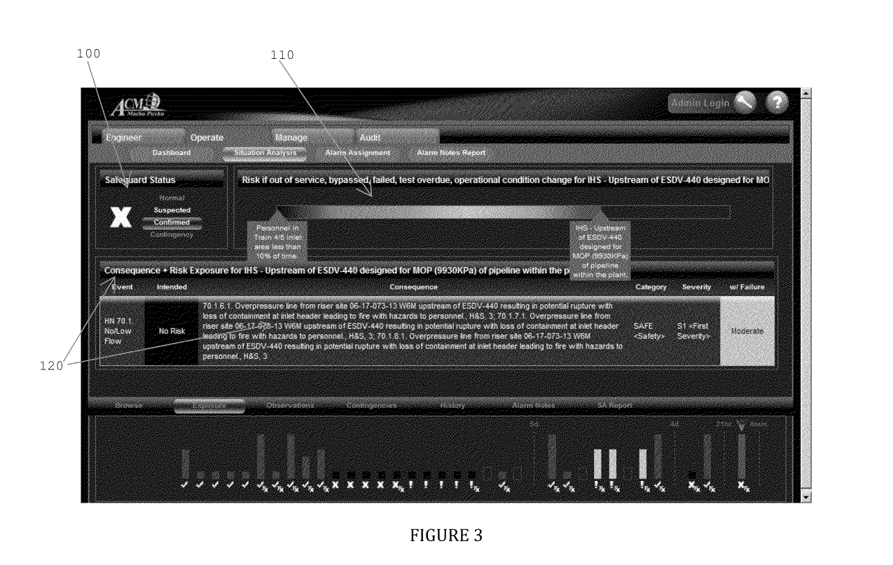

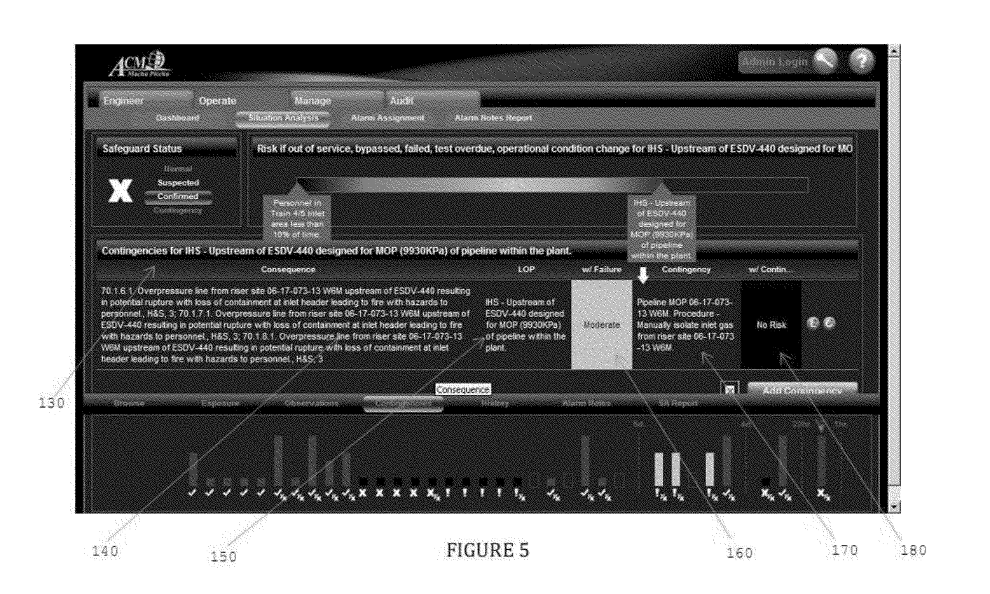

Referring to FIG. 3, a situational analysis screen of the user interface is illustrated. The situation analysis screen provides the safety operator with data relating to the potential consequences of an unsafe situation. A safeguard status section 100 shows the current status of a potentially unsafe situation currently being viewed on the situation analysis screen. The safety operator can select NORMAL to change the status of the potentially unsafe situation to normal, representing that the situation is no longer unsafe. Selecting the SUSPECTED category in the status section 100 will change the status of the potentially unsafe situation to suspected, representing that the situation is potentially unsafe. Selecting the CONFIRMED category in the status section 100 will change the status of the potentially unsafe situation to confirmed, representing that the situation is confirmed to be unsafe. Selecting the CONTINGENCY category in the status section 100 will prompt the safety operator to select an appropriate contingency (FIG. 5) to mitigate the unsafe situation.

A risk bar section 110 presents the safety operator with a visual indication as to the risk being run if the potentially unsafe situation is allowed to continue. The color on the risk bar shows how much risk is being taken. In this implementation, green indicates minimal risk, yellow indicates more risk and red indicates high risk. As can be seen in the risk bar section, multiple situations are represented on the risk bar. The situation indicated by the gray box to the left of the risk bar is one where the risk is minimal while the situation indicated by the gray box to the right of the risk bar indicates a situation where the risk is large.

A consequence section 120 details the consequences if the potentially unsafe situation is allowed to continue. As can be seen from FIG. 3, this section details not just the event, but also a detailed description of the consequence, the category of the consequence (i.e. what it affects), the severity of the consequence, and the risk as to whether the consequence will occur if the component fails. Finally, the consequence section also shows whether the design or use of the component was intended to engender any risks (i.e. are risks expected with this component).

It should be noted that the consequences are categorized into a number of categories. The number of categories are determined by the implementation of the system. While other categories are possible some examples of such categories are:

SAFETY—the consequence relates to the safety of the workers or of the facility

ENVIRONMENTAL—the consequence relates to an environmental impact

ECONOMIC—the consequence relates to a potential economic impact on the business

It should further be noted that the risk levels shown in the consequences section may be categorized into multiple levels. In one implementation, the risk levels were categorized into ACCEPTABLE, MODERATE, or SERIOUS. These levels were, in this implementation, also color coded with ACCEPTABLE being shown by a green field, MODERATE being shown by a yellow field, and SERIOUS being denoted by a red field.

The situational analysis screen in FIG. 3 has multiple views. FIG. 3 shows the exposure view where the safety operator can view the risk exposure for the various potentially unsafe situations

It should be noted that the component relating to each potentially unsafe situation is identified in each section in which the potentially unsafe situation is being examined. As can be seen, the component name is not limited to part numbers but can be quite descriptive. In both FIGS. 2 and 3 one element is named as “IHS—Upstream of ESDV-440 designed for MOP (9930 KPa) of pipeline within the plant” and, from FIG. 2, the failure of this component has been confirmed by the safety operator.

Also part of the situational analysis screen is a quick reference timeline 90 similar to the timeline found in FIG. 2.

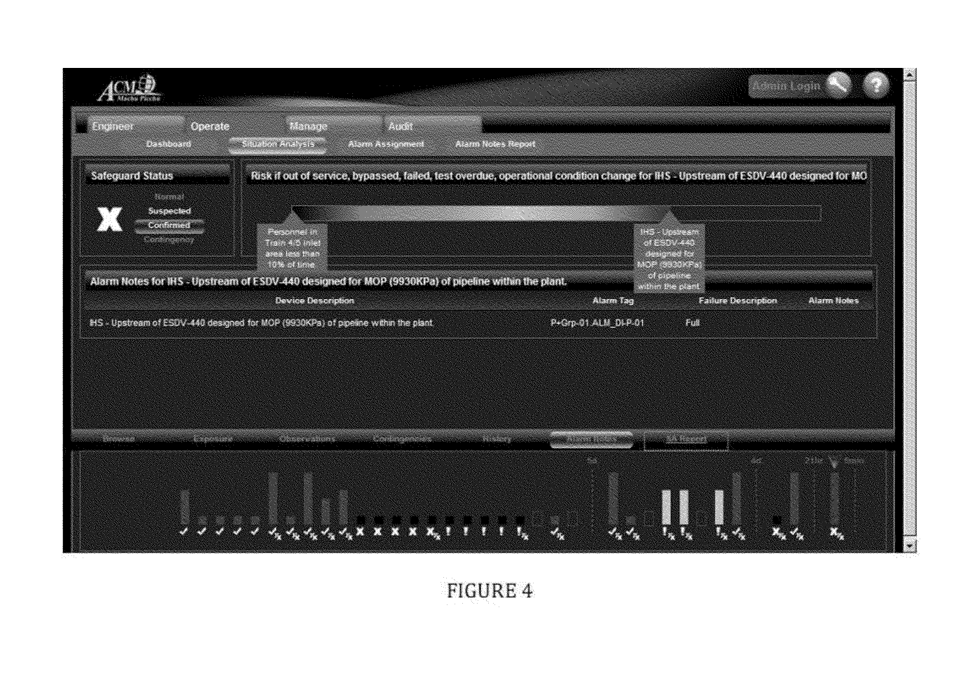

Referring to FIG. 4, another view of the situational analysis screen is illustrated. The view in FIG. 4 provides the safety operator with alarm notes regarding one of the potentially unsafe situations. From FIG. 4, the notes relate to the alarm generated for the IHS component whose failure has been confirmed by the safety operator.

To compensate for the issues caused by an unsafe situation (perhaps caused by a failure of a component), contingencies for each unsafe situation are provided for in the situational analysis screen. Referring to FIG. 5, the contingencies view is shown. This view provides the safety operator with the contingency for each potentially unsafe situation. A contingency section 130 displays not just the potential consequence (see consequence portion 140) but also identifies the component whose failure can cause the consequence (component portion 150), and the risk of the consequence occurring if the component fails (risk portion 160). The contingency section also identifies the contingency for a component failure (contingency portion 170) and the risk of the consequence if the contingency is implemented (modified risk portion 180). For this example, the consequences are quite dire as a fire is possible with its attendant dangers to personnel and the risk of the consequence occurring is moderate. With the contingency in place, the risk of the consequence has been eliminated.

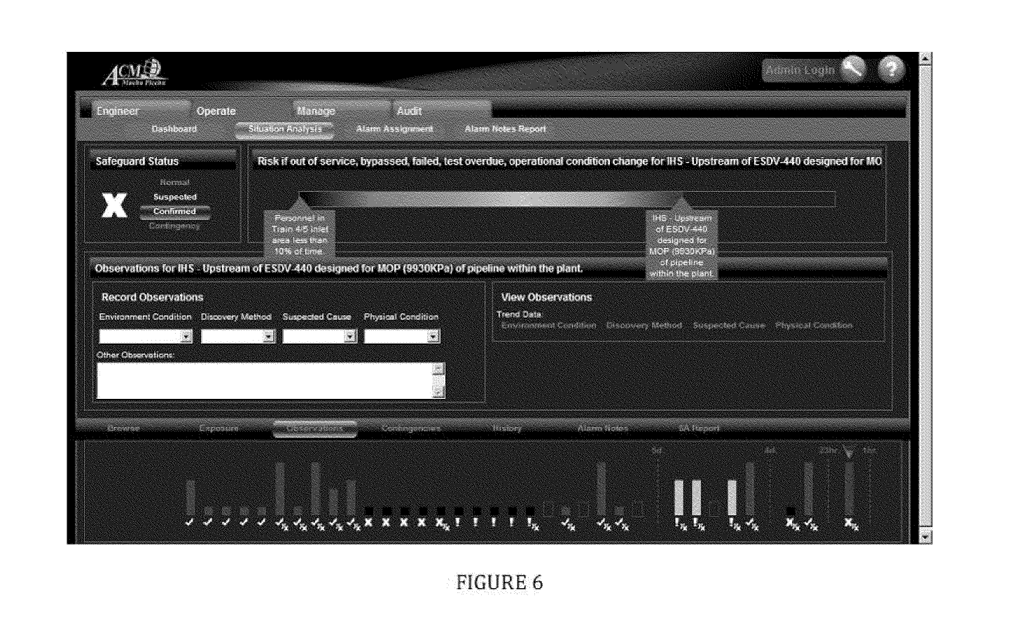

Referring to FIG. 6, shown is the observation view of the situational analysis screen. This view allows the safety operator to add his or her observations regarding the potentially unsafe situation. These observations then become part of the permanent record for that component. The observations are added to the safety document for the particular component, with the safety document being uploaded to the database. Any future access to the safety record for that component will then be able to retrieve the observations for this potentially unsafe situation for this component.

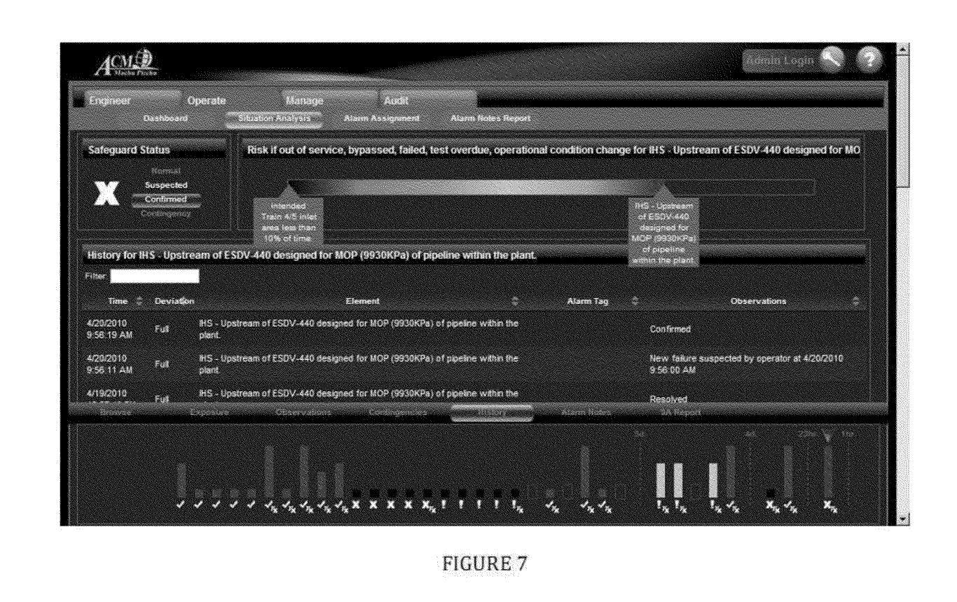

Referring to FIG. 7, the safety operator can review the history of the particular component through the situational analysis screen. This historical view available through the situational analysis screen provides the safety operator with a complete history of any anomalies, problems, alarms, and potential issues with the particular component. The alarm view also provides any alarm tags associated with each event concerning the particular component, the date and time of each event, as well as any observations made regarding the event by the safety operator at the time. As can be seen from FIG. 7, a previous issue with the particular component was resolved while the current issue was first suspected and then confirmed by the safety operator.

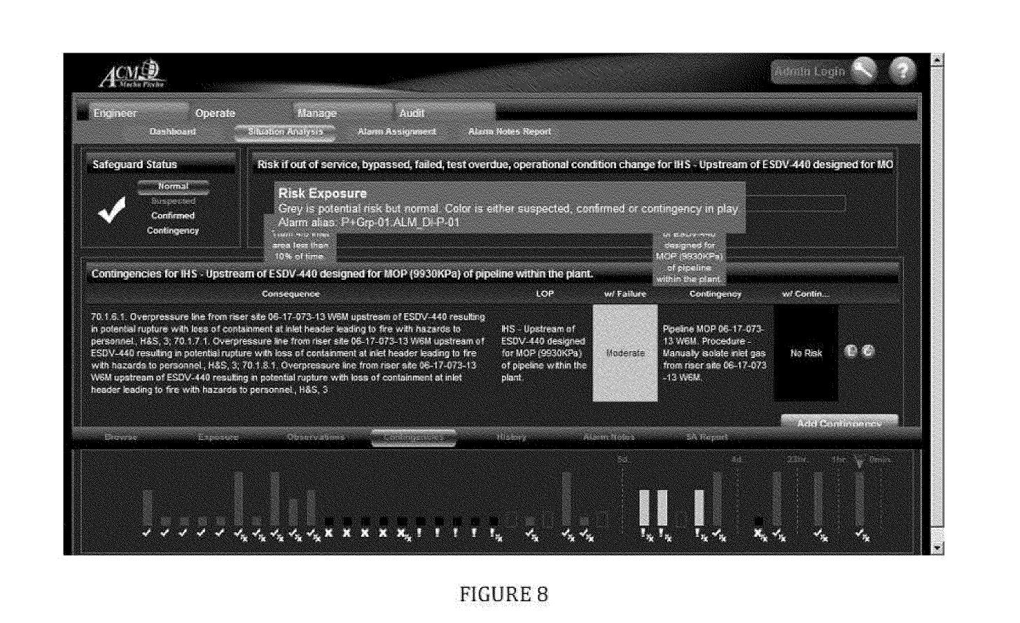

FIG. 8 is a screen shot of the situational screen using the contingency view detailing normal safeguard status. As explained in the mouse over (hovering a pointer over a specific section gives a popup explanation of that section) illustrated in FIG. 8, the safeguard status section is color coded. If there are suspected alarms, confirmed failures, or contingencies in effect, these will be indicated by a non-grey color. This use of a non-grey color to indicate suspected alerts, failures, etc. can be seen in the safeguard status in FIGS. 3,5, and 5 as well.

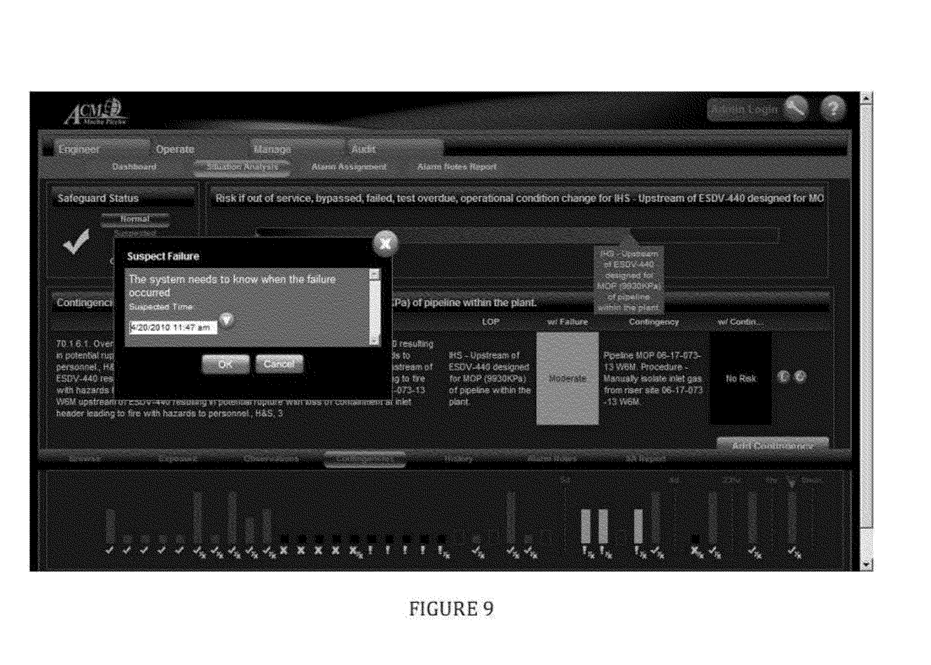

FIG. 9 details a popup window when a failure of a component is suspected. As can be seen, the safety operator is prompted for details, such as date and time, regarding the suspected component failure.

The system 10 operates with the user interface retrieving relevant safety documents from the database. As noted above, each component in the facility has at least one safety document in the database. Each component's safety data, including contingencies, schedules, safety history, and notes and observations on relevant safety alarms concerning the component, are detailed in the safety documents. When a safety operator accesses data regarding a component, this causes the safety documents relating to that component to be retrieved from the database. The relevant data in the safety documents are then presented to the safety operator. This relevant data may, depending on the screen on the user interface, include the contingencies for component failure, the component's history (including false alarms, suspected failures, confirmed failures, etc., etc.), maintenance schedules, safety operator notes and observations, as well as other safety related data.

The safety document(s) for each component may be added to by the safety operator if alerts, potentially unsafe situations, or failures occur. The data regarding such events are then entered into the relevant safety documents for the affected/relevant components. The amended safety documents are then uploaded to the database.

The risk data (i.e. the data relating to the risk of the consequences occurring) are retrieved by the user interface from the calculation module. The calculation module calculates this risk data based on safety data retrieved from the relevant safety documents from the database.

It should be noted that the safety documents or the data contained in these documents may be pre-retrieved by the user interface or by the calculation module prior to being needed by either of these. As an example, the user interface may retrieve all the safety documents from the database for all the components when the user interface is initialized. These safety documents can then be cached until needed by the user interface. Similarly, the risk data for various contingencies and components may be pre-calculated by the calculation module and cached by the user interface until needed or the risk data may be saved in the relevant safety documents for use by the user interface when needed.

In one embodiment, the present invention is implemented as a software system having multiple modules. The user interface module, the database, and the calculation module may be implemented on a single computer. Alternatively, each module may be resident on a separate server with each server being in networked communication with every other server. Similarly, some of the modules may be resident on the same server while others may be on another server.

In one implementation, the calculation module may be the SilCore™ tool marketed by ACM Facility Safety of Calgary, Alberta, Canada.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above, all of which are intended to fall within the scope of the invention as defined in the claims that follow.

1. A system for monitoring safety related procedures relating to specific components in a facility, the system comprising:
a safety operator user interface for providing a safety operator with alarms and information relating to a plurality of components in said facility;
a database of safety related documents, said documents being accessed by said user interface to determine if safety procedures for said plurality of components are being implemented;
a safety calculation module for calculating risk levels and for graphically presenting said risk levels to said safety operator through said user interface using a color coded system, said risk levels being related to a probability of at least one consequence occurring in the event safety procedures for said plurality of components are not implemented.

2. A system according to claim 1 wherein said system alerts said safety operator about scheduled safety inspections for each of said plurality of components on said user interface.

3. A system according to claim 2 wherein missed safety inspections are presented on said user interface using a timeline.

4. A system according to claim 1 wherein, in the event of a potentially unsafe situation concerning at least one of said plurality of components, said user interface provides contingency options to said safety operator.

5. A system according to claim 4 wherein said contingency options are derived from said safety related documents.

6. A system according to claim 1 wherein, in the event of a potentially unsafe situation concerning at least one of said plurality of components, said user interface provides said user operator with potential consequences for said potentially unsafe situation.

7. A system according to claim 6 wherein said risk levels are related to a risk that said potential consequences will occur if said potentially unsafe situation occurs.

8. A system according to claim 7 wherein said user interface provides contingency options to said safety operator for said potentially unsafe situation.

9. A system according to claim 8 wherein, for each contingency option provided to said safety operator, said user interface also provides a modified risk level relating to said potential consequences, said modified risk level being a risk level that said potential consequences will occur if said contingency option is implemented.

10. A system according to claim 1 wherein said user interface displays potentially unsafe events to said safety operator on a timeline.

11. A system according to claim 5 wherein said user interface displays a risk level for said potentially unsafe situation, said risk level being calculated by said safety calculation module, said user interface displaying a modified risk level for each contingency option for said potentially unsafe situation.

12. A system according to claim 1 wherein, for each potentially unsafe situation concerning at least one of said plurality of components, said user interface displays a listing of consequences if said potentially unsafe situation occurs.

13. A system according to claim 1 wherein each one of said consequences is classified as to severity of said consequence.

14. A system according to claim 1 wherein each one of said consequences is classified according to a plurality of categories.

15. A system according to claim 14 wherein said plurality of categories includes at least one of:
safety
environmental
economic

16. A system according to claim 6 wherein said potentially unsafe situation comprises at least one of:
catastrophic failure of said at least one of said components
failure of said at least one of said components to perform according to expected parameters.

17. A system according to claim 1 wherein said user interface displays to said safety operator any contingencies options currently implemented.

18. A system according to claim 1 wherein risk levels are categorized as acceptable, moderate, or serious.

19. A system according to claim 1 wherein said user interface provides said safety operator with a section for entering notes regarding potentially unsafe situations.

20. A system for monitoring safety related procedures relating to specific components in a facility, the system comprising:
a user interface for providing alarms and information relating to said specific components;
a database of safety related documents, said documents being accessed by said user interface to determine if safety procedures for said specific components are being implemented;
a safety calculation module for calculating and graphically presenting risk levels to said user using a color coded system through said user interface, said risk levels relating to a probability of potential consequences occurring in the event said safety procedures for said specific components are not implemented.

21. A system according to claim 20 wherein said user interface provides alerts to said safety operator, said alerts relating to potentially unsafe situations due to a non-implementation of said safety procedures.

22. A system according to claim 20 wherein said potentially unsafe situations comprise at least one of the following:
a failure of at least one of said specific components
an underperformance of said at least one specific components

23. A system according to claim 21 wherein said user interface provides said safety operator with potential consequences for said potentially unsafe situations.

24. A system according to claim 23 wherein risk levels for each of said potential consequences are displayed on said user interface for said safety operator.

25. A system according to claim 24 wherein said user interface provides said safety operator with at least one contingency option for said potentially unsafe situations.

26. A system according to claim 25 wherein modified risk levels are provided to said safety operator through said user interface for each of said contingency options, said modified risk levels being risk levels that said consequences will occur if said contingency options are implemented.

27. A system according to claim 25 wherein said contingency options are derived from said safety documents.
